(19) United States
(12) Patent Application Publication
(10) Pub. No.: US 2015/0306895 A1
(43) Pub. Date: Oct. 29, 2015

(54) COMBINED CLIP AND MEMO PAD FOR OFFICE USE

(71) Applicant: Jongjin KIM, yangju-si Gyeonggi-do (KR)

(72) Inventor: Jongjin KIM, Yangju-si, Gyeonggi-do (KR)

(21) Appl. No.: 14/442,843

(22) PCT Filed: Oct. 29, 2013
(86) PCT No.: PCT/KR2013/009681

§ 371 Date: May 14, 2015

(30) Foreign Application Priority Data
Nov. 16, 2012 (KR) 10-2012-0129840

(51) Int. Cl. B42D 5/00; B42D 9/00; B42F 1/02

(52) U.S. Cl. CPC B42D 5/006; B42F 1/02; B42D 9/005

(57) ABSTRACT

According to a feature of the present invention, a combined clip and memo pad for office use comprises: a lower plate; an upper plate stacked on the lower plate and provided with a space portion formed inwardly so that the memo pad can be inserted therein; a cover rotatably coupled to the upper plate for covering the space portion; a rotary shaft coupled between the lower plate and the upper plate so that the lower plate and the upper plate are rotatably coupled to each other; and a torsion spring coupled to the rotary shaft and elastically operated so as to generate pressure while the lower plate and the upper plate get closer to each other at one side. According to the present invention, since the space portion is formed in the clip comprising the upper plate and the lower plate, it is possible to carry the memo pad in the space portion, thereby providing the combined clip and memo pad for office use which can be used conveniently.

### TECHNICAL FIELD

The present invention relates to an office clip combined with a memo pad, and more particularly, to an office clip combined with a memo pad capable of immediately using memo pads provided in a space of the clip if necessary when a clip including an upper plate and a lower plate is used.

### BACKGROUND ART

In general, memo pads (for example, post-it notes) are frequently used in an offices, homes, schools and institutes. Particularly, the memo pads are frequently used in lecture rooms where people take notes or write additional description.

Further, there are various types of memo pads. There are memo pads layered by applying an adhesive to only one sides and memo pads layered by alternately applying an adhesive to both surfaces. There are various types of meme pads depending on the purpose of use.

However, the memo pads are used in the fixed state in the office or home while the memo pads are provided within a memo pad container, or the memo pads are used by a user who carries the memo pads.

Moreover, when the user carries the memo pads, the memo pads are damaged, and are highly likely to be lost. Since there are various types of memo pads, the user does not carry all types of memo pads, and thus, there are inconvenience and cumbersomeness.

Meanwhile, the clip is an office supply that is used to file documents. Other office supplies are frequently used as alternatives of the clip, but there is a difficulty in carrying various office supplies.

### DISCLOSURE

### Technical Problem

In order to solve such problems, an object of the present invention is to provide an office clip combined with a memo pad capable of conveniently using a clip and memo pads by forming the space within the clip including an upper plate and a lower plate so as to efficiently store the memo pads in the space.

Further, another object of the present invention is to an office clip combined with a memo pad capable of easily using various types of memo pads if necessary by storing the memo pads in the clip.

### Technical Solution

In order to solve such objects, according to an embodiment of the present invention, there is provided an office clip combined with a memo pad. The office clip includes a lower plate: an upper plate that is layered on the lower plate, and has a space which is recessed inward so as to allow memo pads to be inserted; a cover that is rotatably coupled to the upper plate to cover the space; a rotational shaft that is coupled between the lower plate and the upper plate, and allows the lower plate and the upper plate to be rotatably coupled to each other; and a torsion spring that is coupled to the rotational shaft, and are elastic so as to generate pressurization force by allowing the lower plate and the upper plate to be collected toward one side.

Further, the memo pads may be layered by applying an adhesive to one sides, or by alternately applying an adhesive to both sides.

Furthermore, the space may include a first space and a second space to which memo pads are respectively inserted, and the cover may be rotatably coupled between the first space and the second space to selectively cover the first space or the second space.

Moreover, one sides of the first space and the second space may be open.

In addition, the lower plate may have a third space to which memo pads are inserted by forming a lower surface to be recessed inward, coupling protrusions facing each other may be formed on an upper side of the third space, and the memo pads inserted into the third space may be fixed by the coupling protrusions.

Further, the upper plate may be recessed in ward so as to allow the memo pads to be inserted, and has a fourth space of which one surface is open, and the cover may simultaneously cover the second space and the fourth space.

### Effect of the Invention

According to the present invention, it is possible to provide an office clip combined with a memo pad capable of conveniently using a clip and memo pads by forming the space within the clip including an upper plate and a lower plate so as to efficiently store the memo pads in the space.

Furthermore, according to the present invention, it is possible to provide an office clip combined with a memo pad capable of carrying various types of memo pads and improving efficiency of the clip by forming a plurality of spaces within a clip.

### DESCRIPTION OF DRAWINGS

FIGS. 1 and 2 are perspective views showing an office clip combined with a memo pad according to a preferred embodiment of the present invention.

FIG. 3 is a perspective view showing a state where a cap of the office clip combined with a memo pad according to a preferred embodiment of the present invention is opened.

FIG. 4 is a bottom perspective view showing a lower plate of the clip combined with a memo pad according to the preferred embodiment of the present invention.

FIG. 5 is an exploded diagram showing the clip combined with a memo pad according to the preferred embodiment of the present invention.

FIG. 6 is a side view of the clip combined with a memo pad according to the preferred embodiment of the present invention.

FIG. 7 is a diagram showing the clip combined with a memo pad according to the preferred embodiment of the present invention.

FIG. 8 is a diagram showing an utilization example of the clip combined with a memo pad according to the preferred embodiment of the present invention.

### BEST MODE

Merits and characteristics of the present invention, and methods for accomplishing them will become more apparent from the following embodiments taken in conjunction with the accompanying drawings. However, the present invention is not limited to the disclosed embodiments, but may be implemented in various manners. The embodiments are provided to complete the disclosure of the present invention and to allow those having ordinary skill in the art to understand the scope of the present invention. The present invention is defined by the category of the claims. The same reference numbers will be used throughout the drawings to refer to the same or like parts.

Hereinafter, the present invention will be described with reference to the drawings for describing an office clip combined with a memo pad according to embodiments of the present invention.

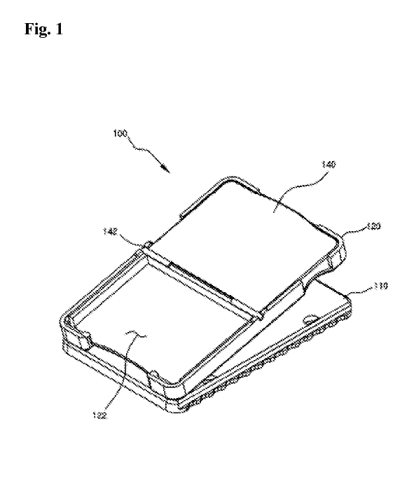

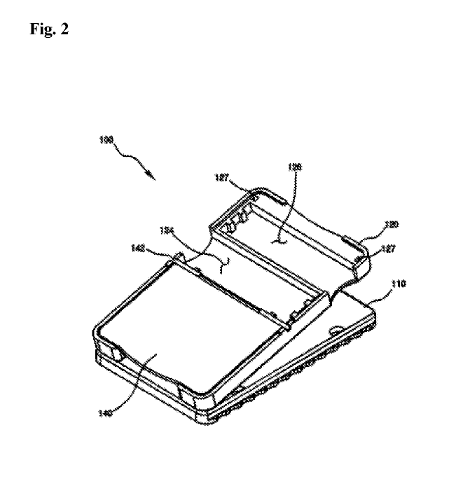

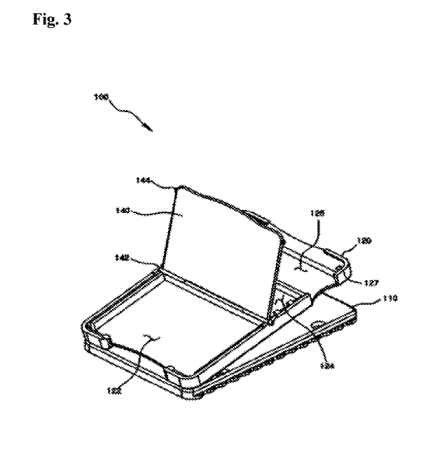

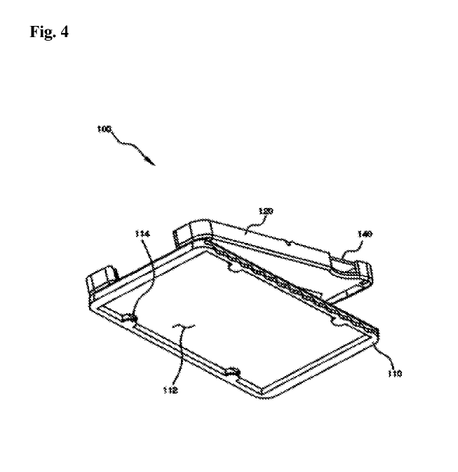

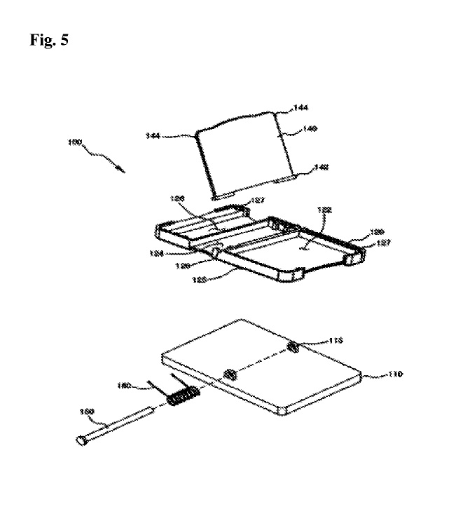

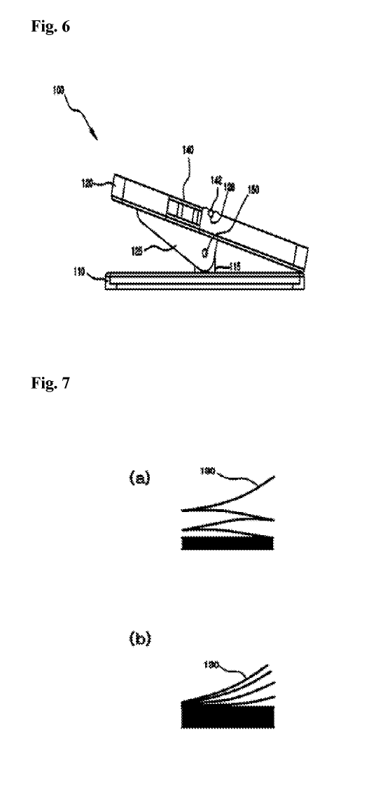

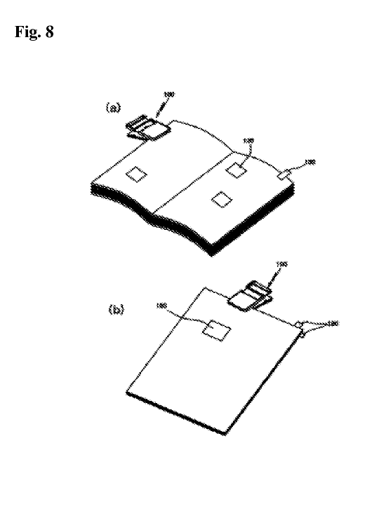

FIG. 1 and FIG. 2 are perspective views showing an office clip combined with a memo pad according to a preferred embodiment of the present invention. FIG. 3 is a perspective view showing a state where a cap of the office clip combined with a memo pad according to the preferred embodiment of the present invention is opened. FIG. 4 is a bottom perspective view showing a lower plate of the office clip combined with a memo pad according to the preferred embodiment of the present invention. FIG. 5 is an exploded diagram showing the office clip combined with a memo pad according to the preferred embodiment of the present invention. FIG. 6 is a side view showing the office clip combined with a memo pad according to the preferred embodiment of the present invention. FIG. 7 is a diagram showing the office clip combined with a memo pad according to the preferred embodiment of the present invention. FIG. 8 is a diagram showing a utilization example of the office clip combined with a memo pad according to the preferred embodiment of the present invention.

Referring to FIG. 1 to FIG. 6, an office clip 100 combined with a memo pad according to the preferred embodiment of the present invention includes a lower plate 110, an upper plate 120, memo pads 130, a cover 140, a rotational shaft 150, and a torsion spring 160.

The clip 100 may be used by coupling the lower plate 110 to the upper plate 120 through the torsion spring 160.

The lower plate 110, that is, a lower surface of the lower plate 110 is recessed inward, and, thus, a third space 112 is formed. Coupling protrusions 114 that face each other are preferably formed on both sides on an upper side of the third space 112.

In this case, the memo pads 130 are inserted into the third space 112, and the memo pads 130 are fixed by the coupling protrusions 114.

The upper plate 120 is layered on the lower plate 110, and a space that is recessed inward is formed on an upper surface of the upper plate 120 so as to allow the memo pad to be inserted. The space in the present embodiment includes a first space 122 and a second space 124 to which memo pads are respectively inserted.

In this case, the first space 122 and the second space 124 preferably have a size corresponding to the size of the memo pads 130 so as to allow the memo pads 130 to be inserted.

Further, one sides of the first space 122 and the second space 124 are open, so that the memo pads 130 can be easily taken off one by one, or the memo pads 130 can be easily refilled.

A fourth space 126 is further formed in the upper plate 120, and the memo pads 130 are preferably provided in the fourth space 126. Furthermore, one side of the fourth space 126 is open, so that the memo pads 130 can be easily taken off one by one, or the memo pads 130 can be easily refilled.

Here, the one sides of the second space 124 and the fourth space 126, which are open, may be formed so as to face each other.

Moreover, the first space 122, the second space 124, or the fourth space 126 are opened or closed by the cover, to be described below.

The memo pads 130 are respectively inserted into the first space 122 to the fourth space 126.

Referring to FIG. 7, the memo pads 130 are layered by applying an adhesive to one sides or by alternately applying an adhesive to both sides, but the present invention is not limited thereto.

The cover 140 is rotatably coupled to between the first space 122 and the second space 124 to cover the first space 122 or the second space 124.

Fixing protrusions 144 are formed on both sides of the cover 140, that is, both sides on an upper side, and the fixing protrusions 144 are inserted into fixing grooves 127 formed on inner surfaces on both sides of the upper side of the first space 122.

That is, the cover 140 may be fixed to the first space 122 when the first space 122 is closed.

Here, when the cover 140 closes the second space 124 by being rotated by engaging shafts 142, to be described below, the fixing grooves 127 are preferably formed on the upper side of the upper plate such that the fixing protrusions 144 are coupled when the cover 140 closes the second space 124.

In addition, the engaging shafts 142 are formed on both sides of the cover 140 so as to protrude outward.

Furthermore, shaft grooves 128 to which the engaging shafts 142 are coupled are formed between the first space 122 and the second space 124. In other words, the shaft grooves 128 are formed on the upper surface of the upper plate 120, and the shaft grooves 128 are formed between the first space 122 and the second space 124.

That is, the engaging shafts 142 of the cover 142 are rotatably coupled to the shaft grooves 128. Moreover, when the first space 122 is closed by the cover 140, the second space 124 is opened, and the memo pads 130 are taken out and used. Meanwhile, when the second space 124 is closed by the cover 140, the first space 122 is opened, and the memo pads 130 are taken out and used.

Here, the structure in which the cover 140 is rotatably coupled between the first space 122 and the second space 124 may be variously configured.

The rotational shaft 150 is provided between the lower plate 110 and the upper plate 120, and the lower plate 110 and the upper plate 120 are rotatably coupled.

Here, protrusions 115 and 125 that protrude are formed on the lower surface of the upper plate 120 and the upper surface of the lower plate 110.

That is, the rotational shaft 150 is coupled to the protrusions 115 and 125 by being inserted therein, and the lower plate 110 and the upper plate 120 are coupled. Thus, the upper plate 120 and the lower plate 110 are rotatably coupled.

The torsion spring 160 is coupled to the rotational shaft 150. The lower plate 110 and the upper plate 120 are collected toward one side, and are elastic so as to generate pressurization force.

The torsion spring 160 is a bar-shaped spring that is subjected to twisting and is elastically deformed, and is frequently used for the clip 100.

The clip 100 of the present invention is used when a book or sheets of A4 paper.

That is, according to the office clip 100 combined with the memo pads 130 of the present invention, since the first space 122, the second space 124, the third space 112 and the fourth space 126 are formed in the clip including the upper plate 120 and the lower plate 110, the memo pads 130 can be stored in the first space 122, the second space 124, the third space 112 and the fourth space 126, so that it is possible to conveniently use the clip 100 and the memo pads 130.

In addition, the office clip 100 of the present invention can store office supplies such as clips in the first space 122, the second space 124, the third space 113 or the fourth space 126 that is combined with the memo pads 130 depending on the convenience of the user. Thus, it is possible to variously use the first space 122, the second space 124, the third space 112 or the fourth space 126.

Meanwhile, although it has been described in the aforementioned embodiment that the first space 122, the second space 124 and the fourth space 126 are formed in the upper plate 120, and the third space 112 is formed in the lower plate 110, the present invention is not limited. A single space into which the memo pads are inserted may be formed in only the upper plate 120.

It will be understood to those skilled in the art that the present invention may be implemented in different specific forms without changing the technical ideals or essential features. Accordingly, it should be understood that the embodiments described herein are illustrative not restrictive in all aspects. The scope of the present invention is defined by the appended claims rather than the detailed description, and all changes or modifications derived from the meaning and scope of the claims the accompanying claims and their equivalents are interpreted as being incorporated within the scope of the present invention.

1. An office clip combined with a memo pad, comprising:
a lower plate;
an upper plate that is layered on the lower plate, and has a space which is recessed inward so as to allow memo pads to be inserted;
a cover that is rotatably coupled to the upper plate to cover the space;
a rotational shaft that is coupled between the lower plate and the upper plate, and allows the lower plate and the upper plate to be rotatably coupled to each other; and
a torsion spring that is coupled to the rotational shaft, and are elastic so as to generate pressurization force by allowing the lower plate and the upper plate to be collected toward one side.

2. The office clip combined with a memo pad according to claim 1,
wherein the memo pads are layered by applying an adhesive to one sides, or by alternately applying an adhesive to both sides.

3. The office clip combined with a memo pad according to claim 1,
wherein the space includes a first space and a second space to which memo pads are respectively inserted, and
the cover is rotatably coupled between the first space and the second space to selectively cover the first space or the second space.

4. The office clip combined with a memo pad according to claim 3,
wherein one sides of the first space and the second space are open.

5. The office clip combined with a memo pad according to claim 1,
wherein the lower plate has a third space to which memo pads are inserted by forming a lower surface to be recessed inward,
coupling protrusions facing each other are formed on an upper side of the third space, and
the memo pads inserted into the third space are fixed by the coupling protrusions.

6. The office clip combined with a memo pad according to claim 3,
wherein the upper plate is recessed in ward so as to allow the memo pads to be inserted, and has a fourth space of which one surface is open, and
the cover simultaneously covers the second space and the fourth space.
